(19) United States
(12) Patent Application Publication
(10) Pub. No.: US 2009/0113713 A1
(43) Pub. Date: May 7, 2009

(54) Method for Making a Wheel Rim

(76) Inventors: Wang-Fa Tsai, Changhua Hsien (TW); Shou-Chang Hwang, Changhua Hsien (TW)

Correspondence Address: WHYTE HIRSCHBOECK DUDEK S C;INTELLECTUAL PROPERTY DEPARTMENT, 555 EAST WELLS STREET, SUITE 1900, MILWAUKEE, WI, 53202, US

(21) Appl. No.: 11/933,675

(22) Filed: Nov. 1, 2007

(51) Int. Cl. B23P 17/00

(52) U.S. Cl. 29/894.324

(57) ABSTRACT

A method for making a wheel rim includes the steps of: A) casting an aluminum alloy containing silicon and magnesium into a blank including a lateral portion and a disk portion that is surrounded by the lateral portion and that has a plurality of radial elements extending toward and connected to the lateral portion; B) forging the disk portion of the blank to form the radial elements into radial ribs; C) solution heat-treating the blank after forging; and D) spinning the lateral portion to form a rim body.

### BACKGROUND OF THE INVENTION

1. Field of the Invention

The invention relates to a method for making a wheel rim, more particularly to a method for making a wheel rim involving a casting step.

2. Description of the Related Art

Referring to FIG. 1, a conventional method for making a wheel rim includes the steps of:

1) forging a solid metallic block 1 into a wheel rim blank 5 using different forging molds 2, 3, 4;

2) heat-treating the wheel rim blank 5;

3) spinning the wheel rim blank 5 using a spinning device 6 to form a rim body 501 for the wheel rim blank 5; and

4) milling a solid disk portion of the wheel rim blank 5 and turning a lateral wall portion of the rim body 501 to form a wheel rim 7 having a plurality of ribs 701.

Although the conventional method can be used to make the wheel rim 7, it has the following shortcomings:

1. Since the solid metallic block 1 is used to make the wheel rim blank 5, a plurality of forging procedures using a variety of forging molds are required. Furthermore, an additional heat treatment using a heating furnace is required between two forging procedures. Therefore, the forging step for forming the wheel rim blank 5 of the conventional method should be conducted using a variety of processing devices, and thus is costly and time-consuming.

2. It takes about 4 hours to accomplish the milling of the solid disk portion of the wheel rim blank 5, and a large amount of waste material is produced after the milling procedure. Therefore, the milling procedure is also time-consuming and costly.

3. If the wheel rim to be made has a relatively large size, the numbers of the forging and heat-treating procedures are increased due to the limitation of the allowable deformation for each of the forging procedures. Therefore, it is more difficult to make a wheel rim having a relatively large size using the conventional method.

### SUMMARY OF THE INVENTION

The object of the present invention is to provide a method for making a wheel rim that can overcome the aforesaid shortcomings of the conventional method for making a wheel rim.

Accordingly, a method for making a wheel rim of the present invention includes the steps of:

A) casting an aluminum alloy containing silicon and magnesium into a blank including a lateral portion and a disk portion that is surrounded by the lateral portion and that has a plurality of radial elements extending toward and connected to the lateral portion;

B) forging the disk portion of the blank to form the radial elements into radial ribs;

C) solution heat-treating the blank after forging; and

D) spinning the lateral portion to form a rim body.

### BRIEF DESCRIPTION OF THE DRAWINGS

Other features and advantages of the present invention will become apparent in the following detailed description of the preferred embodiment with reference to the accompanying drawings, of which:

FIG. 1 illustrates consecutive steps of a conventional method for making a wheel rim;

FIG. 2 is a flowchart of the preferred embodiment of a method for making a wheel rim according to this invention; and

FIGS. 3 to 10 are views illustrating consecutive steps of the preferred embodiment of FIG. 2.

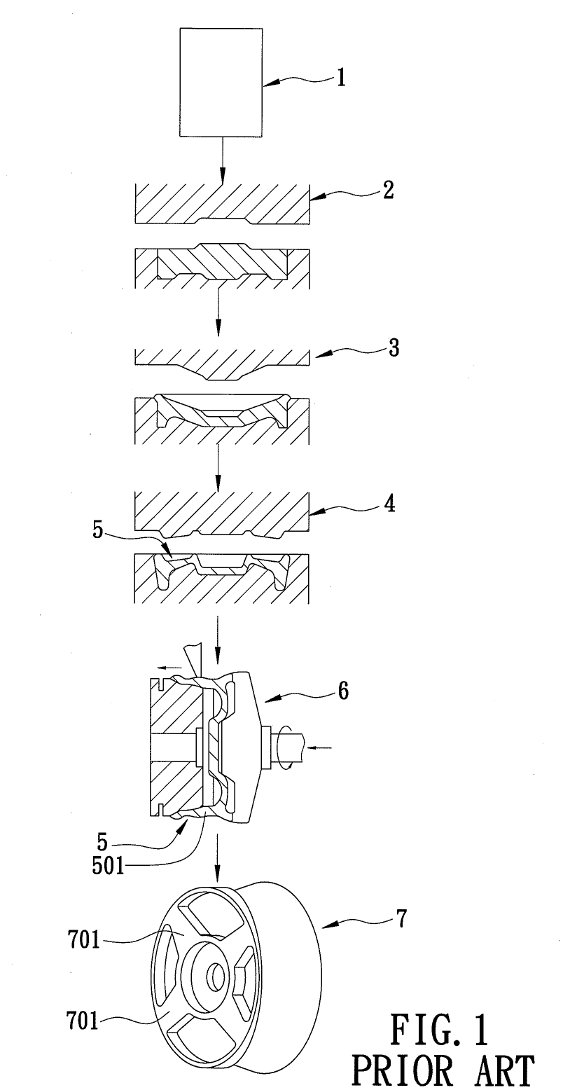

### DETAILED DESCRIPTION OF THE PREFERRED EMBODIMENT

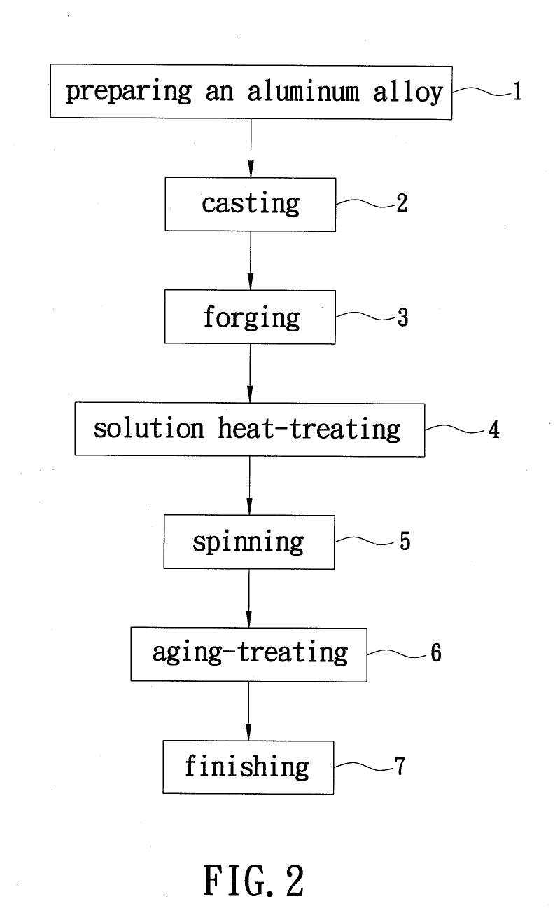

Referring to FIG. 2, the preferred embodiment of a method for making a wheel rim according to this invention includes the steps of:

1) Preparing an Aluminum Alloy:

Preferably, the aluminum alloy used in the method of the present invention includes 3-6 wt % Si, 0.4-0.7 wt % Mg, 0-0.1 wt % Cu, 0-0.12 wt % Fe, 0-0.05 wt % Mn, 0-0.05 wt % Zn, 0-0.05 wt % Ni, 0-0.25 wt % Ti, and a balance of Al, based on the total weight of the aluminum alloy. In the preferred range of the Si amount, the flowability and the feeding effect of the molten aluminum alloy during the following casting step is improved as the Si amount is increased. Better surface finish of a cast blank can be obtained as the Si amount is increased. Additionally, in the preferred range of the Mg amount, the mechanical strength of the cast blank can be improved as the Mg amount is increased due to the increased amount of Mg₂Si.

2) Casting:

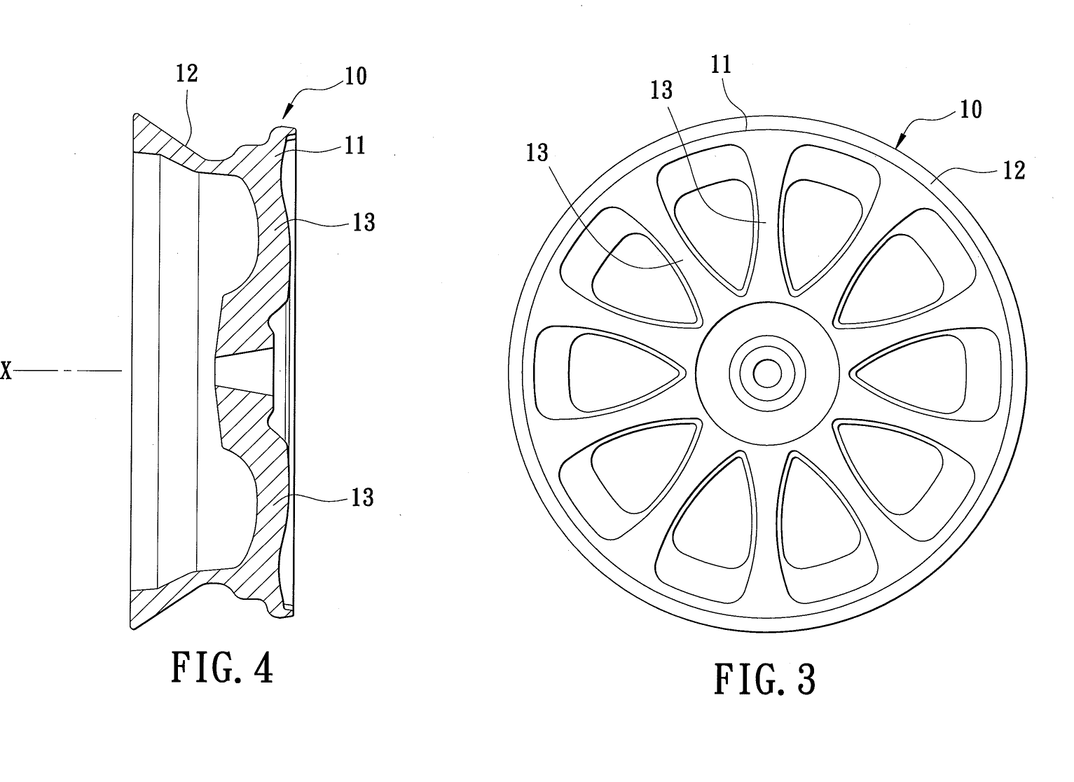

Referring to FIGS. 3 and 4, the aluminum alloy is cast by low pressure casting, gravity casting, or the like, into a blank 10 which includes a lateral portion 12 that surrounds an axis (X) and a disk portion 11 that is surrounded by the lateral portion 12 and that has a plurality of radial elements 13 extending toward and connected to the lateral portion 12. The disk portion 11 of the blank 10 has a profile similar to that of a corresponding portion of the wheel rim to be made.

3) Forging:

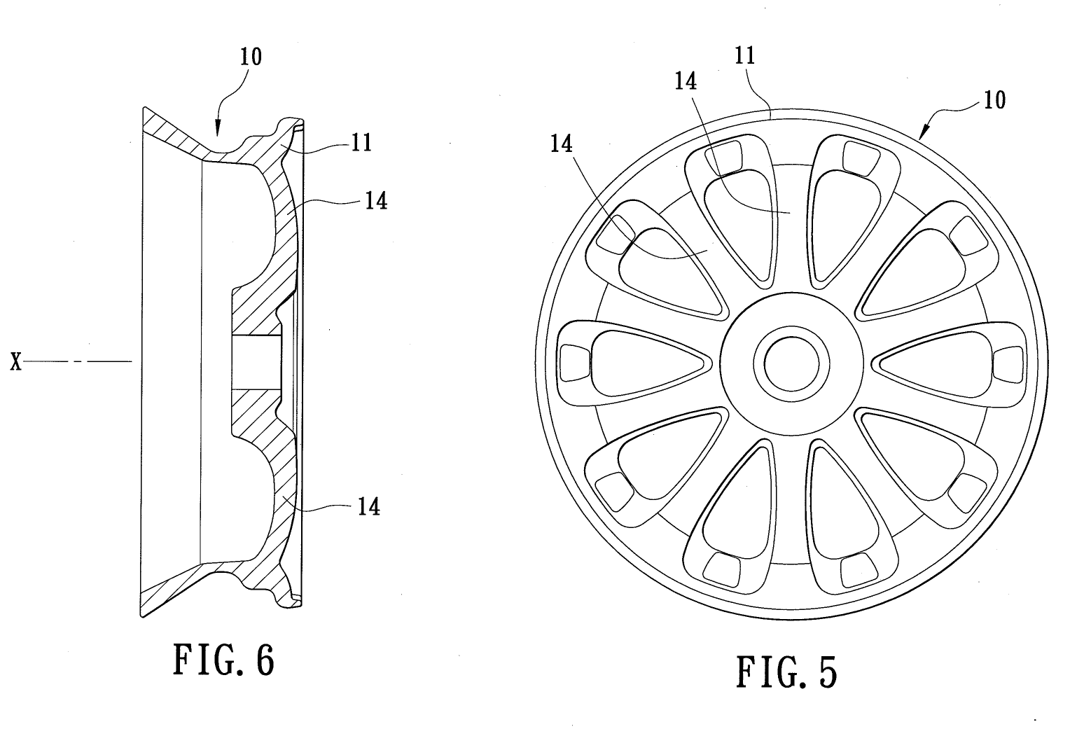

Referring to FIGS. 5 and 6, the disk portion 11 of the blank 10 is forged to form the radial elements 13 into radial ribs 14. Preferably, the forging is conducted at a forging ratio ranging from 30%-70% and at a forging temperature ranging from 430 to 480° C.

4) Solution Heat-Treating:

The blank 10 after forging is treated by a solution heat-treatment, which is conducted by heating the blank 10 to a temperature ranging from 520 to 540° C. for a period ranging from 4 to 8 hours, and water-quenching the blank 10.

5) Spinning:

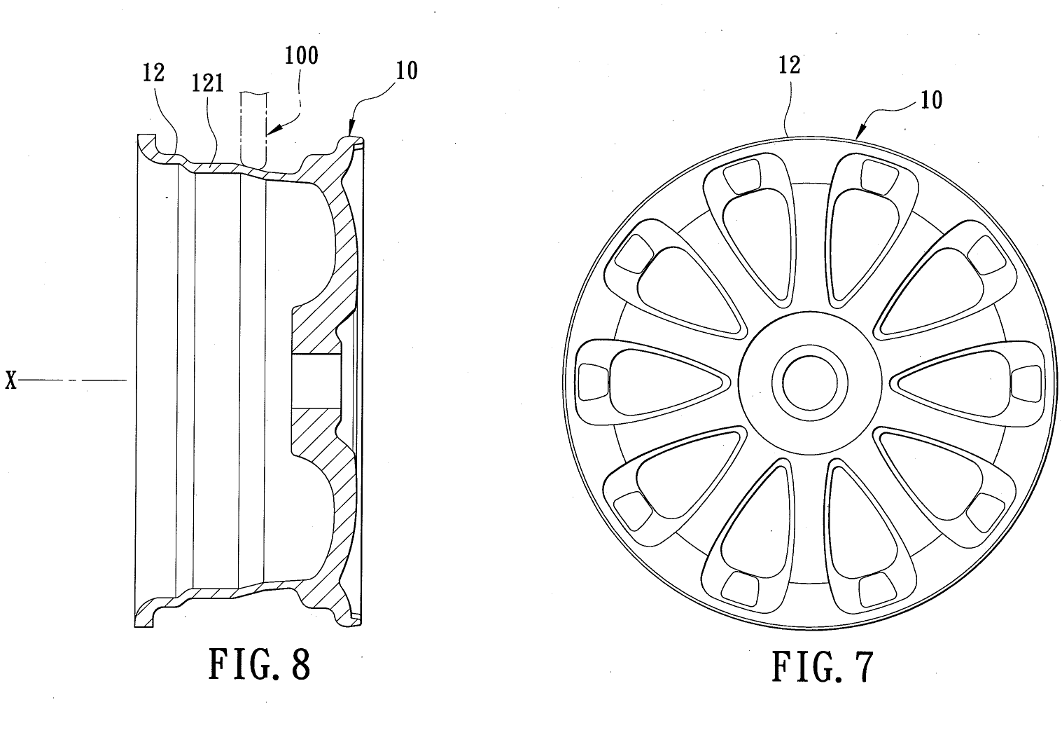

Referring to FIGS. 7 and 8, the lateral portion 12 of the blank 10 is spun using a spinning device 100 to form a rim body 121 having reinforced mechanical strength.

6) Aging-Treating:

The blank 10 is aging-treated by heating the blank 10 to a temperature ranging from 140 to 160° C. for a period ranging from 1 to 7 hours, and air-cooling the blank 10.

7) Finishing:

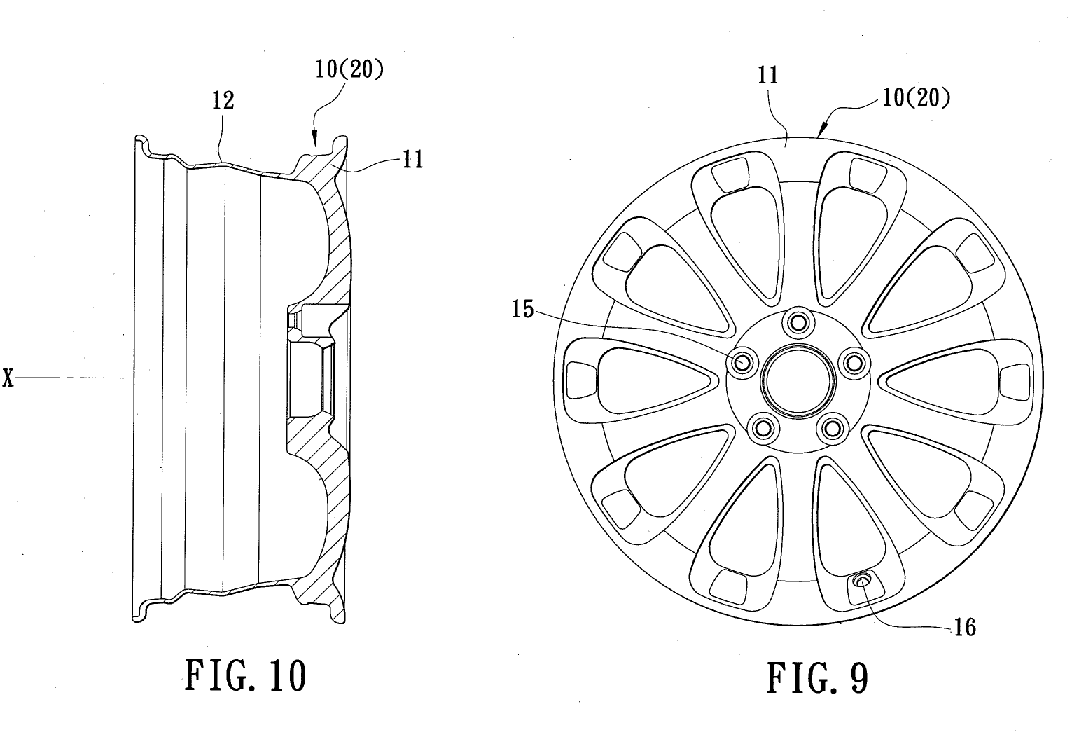

Referring to FIGS. 9 and 10, the blank 10 is further provided with a plurality of fastening holes 15 and a valve hole 16, and the lateral portion 12 of the blank 10 is turned so as to obtain a wheel rim 20. In view of the aforesaid, the present method has the following advantages:

1. The blank 10 made by the casting step of the present method is formed with the disk portion 11 having a profile similar to that of a corresponding portion of the wheel rim 20 to be made. Furthermore, the blank 10 is then processed by a single forging step. Therefore, the aforesaid shortcomings of the prior art due to the requirement of a plurality of forging procedures can be avoided.

2. The blank 10 made by the casting step of the present invention is formed with a plurality of radial elements 13, which are then forged to form the radial ribs 14. Therefore, the time-consuming milling procedure required in the prior art can be avoided, and the waste material produced by the present method can be significantly reduced as compared to the prior art.

3. Since a single forging procedure is required in the present method, the problem regarding the limited allowable deformation of the forging procedures of the prior art can be avoided.

4. Since the blank 10 is made by casting using a suitable mold, the flexibility of the shape of the wheel rim 20 can be increased by the present method.

5. Since suitable amounts of Si and Mg are included in the aluminum alloy used in the present method, the aluminum alloy has a suitable flowability for the casting procedure and a sufficient deformation for the forging procedure.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A method for making a wheel rim, comprising the steps of:
A) casting an aluminum alloy containing silicon and magnesium into a blank including a lateral portion and a disk portion that is surrounded by the lateral portion and that has a plurality of radial elements extending toward and connected to the lateral portion;
B) forging the disk portion of the blank to form the radial elements into radial ribs;
C) solution heat-treating the blank after forging; and
D) spinning the lateral portion to form a rim body.

2. The method as claimed in claim 1, further comprising a step of aging-treating the blank after the step D).

3. The method as claimed in claim 1, wherein the aluminum alloy includes 3-6 wt % Si, and 0.4-0.7 wt % Mg, based on the total weight of the aluminum alloy.

4. The method as claimed in claim 3, wherein the aluminum alloy further includes 0-0.1 wt % Cu, 0-0.12 wt % Fe, 0-0.05 wt % Mn, 0-0.05 wt % Zn, 0-0.05 wt % Ni, and 0-0.25 wt % Ti, based on the total weight of the aluminum alloy.

5. The method as claimed in claim 1, wherein the forging step is conducted at a forging ratio ranging from 30%-70% and at a forging temperature ranging from 430 to 480° C.

6. The method as claimed in claim 1, wherein the solution heat-treating step is conducted by heating the blank to a temperature ranging from 520 to 540° C., and water-quenching the blank.

7. The method as claimed in claim 2, wherein the aging-treating step is conducted by heating the blank to a temperature ranging from 140 to 160° C., and air-cooling the blank.
